(19) United States
(12) Patent Application Publication
(10) Pub. No.: US 2015/0114189 A1
(43) Pub. Date: Apr. 30, 2015

(54) METHOD AND APPARATUS FOR REMOVING UNDERWATER PLATFORMS

(71) Applicant: Jon KHACHATURIAN, New Orleans, LA (US)

(72) Inventor: Jon KHACHATURIAN, New Orleans, LA (US)

(21) Appl. No.: 14/528,647

(22) Filed: Oct. 30, 2014

Related U.S. Application Data
(60) Provisional application No. 61/898,017, filed on Oct. 31, 2013.
(60) Provisional application No. 62/051,640, filed on Sep. 17, 2014.

(51) Int. Cl. E02B 17/04; B23D 57/00

(52) U.S. Cl. CPC E02B 17/04; B23D 57/0084; B23D 57/0007; E02B 2201/00
USPC 83/13

(57) ABSTRACT

A method is provided for removing an abandoned marine platform from a seabed having an upper surface or mud line. The platform extends typically below the seabed and mud line. In order to remove the platform, frame sections are lowered to the seabed with a lift device. A movable cutter cable is fitted to the frame sections. At least a part of the cutter cable is positioned below the mud line. The cutter cable is moved relative to the frame sections to cut the platform below the mud line. Such movement can be a back and forth movement wherein the cutter cable moves in a first direction, stops and then moves in a second direction that is generally opposite the first direction. A lifting device can employ two vessels and two frames, each frame bridging from one vessel to the other. Winches can be used to provide movement to the cutter cable. These same winches can take up cable slack as cutting moves from one platform member (e.g. leg, jacket leg, piling, etc) to another.

### CROSS-REFERENCE TO RELATED APPLICATIONS

Priority of U.S. Provisional Patent Application Ser. No. 61/898,017, filed 31 Oct. 2013, and U.S. Provisional Patent Application Ser. No. 62/051,640, filed 17 Sep. 2014, each of which is hereby incorporated herein by reference, is hereby claimed.

U.S. patent application Ser. No. 14/029,532, filed 17 Sep. 2013, which claims the benefit of U.S. Provisional Patent Application Ser. No. 61/702,125, filed 17 Sep. 2012, are both hereby incorporated herein by reference.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to the removal of abandoned or storm damaged offshore marine platforms or jackets such as oil well drilling or oil well production platforms. Even more particularly, the present invention relates to a method and apparatus for the removal of an abandoned or storm damaged offshore oil well drilling or production platform wherein a specially configured frame is lowered to a part of the platform below water surface and attached to the platform, the frame carrying a cable fitted with cutting members (e.g., tungsten carbide covered cutting members) that can be manipulated with a cable to cut the platform or jacket and wherein once partially cut, the legs of the platform are supported so that the cuts do not close and pinch the cable. In an alternate embodiment, a heavy lift vessel can be used to hold the weight of the platform or jacket being cut.

2. General Background of the Invention

Marine platforms such as oil well drilling platforms and oil well production platforms must be removed once they are abandoned or severely storm damaged. These platforms often include a jacket which is secured to the seabed by means of piling that are driven through vertical or longitudinally extending members of the jacket. Such an arrangement of a jacket that supports a platform is well known in the art (e.g., see U.S. Pat. Nos. 3,955,372; 4,118,942 and 4,389,141, each of which is hereby incorporated herein by reference.

Upon the abandonment of an oil well platform such as a drilling platform or a production platform, the platform must be removed because if left alone it becomes a hazard to navigation. Such abandoned or storm damaged marine platforms are desirably removed in their entirety, including portions that extend below the mudline. By cutting the platform below the mudline, the seabed does not contain hazards to fishermen's nets, as an example.

### BRIEF SUMMARY OF THE INVENTION

The present invention provides a method of removing an abandoned marine platform that extends below a seabed mud line.

A frame surrounds an open center portion. The frame can include left and right frame sections. A cutter cable is fitted to the frame sections. The frame sections are lowered to the seabed next to the platform, wherein the platform occupies the open center portion in between the frame sections.

At least a part of the cutter cable is positioned below the mud line.

The cable is moved back and forth to cut the platform below the mud line.

In one embodiment, the cutter cable includes portions that extend to the water surface area. In one embodiment, a floating lifting apparatus (e.g., see U.S. Pat. Nos. 7,527,006, 7,845,296, 7,886,676, 8,061,289 and 8,240,264, each hereby incorporated herein by reference) lowers the frame sections, the floating lifting apparatus having one or more winches connected to the cutter cable for moving the cutter cable.

In one embodiment, the floating lifting apparatus includes a work platform having winches, and wherein an end portion of the cutter cable is wound upon a said winch.

In one embodiment, the method includes moving the cable in a first direction and then moving the cable in a second direction.

In one embodiment, the cable is moved in a first direction and then the cable is moved in a second direction that is generally opposite the first direction.

In one embodiment, each frame section has an anchor that extends below the mud line.

In one embodiment, each frame section is generally rectangular in shape.

In one embodiment, the cable is moved by winding up cable on one winch while paying out cable from the other winch.

In one embodiment, the cutter cable includes a plurality of sleeves placed upon a wire rope cable.

In one embodiment, each of the sleeves have an outer coating of tungsten carbide members.

In one embodiment, the present invention provides a method and apparatus for removing an abandoned marine platform that extends below a seabed mud line.

The apparatus includes a pair of frame sections that are spaced apart on opposite sides of an open center.

A lifting device lowers the frame sections to the platform, wherein the platform occupies the open center, thus positioned in between the frame sections.

A movable cutter cable is rigged to each frame section.

At least apart of the cutter cable is positioned below the mud line once the frame sections are lowered.

Power units (e.g. winches) move the cable relative to the frame sections to cut the platform below the mud line.

In one embodiment, the cable is pulled in a first direction with a winch located on the lift device and then a second direction by another winch on the lifting device while engaging the platform to be cut.

In one embodiment, the platform has multiple leg members and the cable is moved back and forth until each leg member of the platform is cut.

In one embodiment, the platform includes a jacket that has multiple vertical or inclined members and the cable is moved back and forth until each vertical and inclined member of the jacket is cut.

In one embodiment, the platform is anchored to the seabed with multiple piling members and the cable is moved back and forth until each piling member of the platform is cut.

The present invention provides a method of removing an abandoned marine platform that extends above and below a water surface and into a seabed. The method provides frame sections and multiple winches, affixing the winches to a work platform, rigging a cutter cable to the frame sections and to the winches, one end of the cutter cable being wound upon a first winch, the other end of the cutter cable being wound on a second winch, and moving the cable to cut the platform along a selected cut line, wherein the winches gradually shorten the cable during such cutting.

In one embodiment, the winches gradually shorten the cable by taking up the cable upon one or both of said winches.

In one embodiment, the cutter cable is shortened by taking up the cable upon both of the winches.

In one embodiment, the winches are mounted on the work platform above the water surface.

In one embodiment, the present invention includes moving the cable in a first direction and then moving the cable in a second direction that is not the first direction.

In one embodiment, the present invention includes moving the cable in a first direction and then moving the cable in a second direction that is generally opposite the first direction.

In one embodiment, each frame section has an anchor arm that moves to engage the seabed.

In one embodiment, each frame section has a plurality of sheaves and in step “c” the cable is rigged to a digger arm that moves to engage the seabed.

In one embodiment, the present invention further comprises the step of providing a lifting device and lowering the frame sections to the seabed, wherein a lower portion of each frame section is lowered until below the seabed.

In one embodiment, the cable is moved by winding up cable on one winch while paying out cable from the other winch.

In one embodiment, the cutter cable includes a plurality of sleeves placed upon a wire rope cable.

In one embodiment, the sleeves have an outer coating of tungsten carbide members.

The present invention includes a method of removing an abandoned marine platform that extends below a water surface. The method provides a lifting device having winches and multiple frame sections, lowering the frame sections from the lifting device downwardly with winches mounted on the lifting device to a selected location below the water surface, placing the frame sections next to the platform, using the frame sections to support a movable cutter cable, and wherein the movable cutter cable has first and second portions, moving the first and second portions of the cutter cable relative to the frame sections while taking up the cable with the winches, and cutting the platform with the cable.

In one embodiment, the cable is pulled in a first direction with the first said winch and then a second direction with a second said winch while engaging the platform to be cut.

In one embodiment, the platform has multiple jacket leg members and the cable is moved back and forth until multiple leg members of the platform are cut with the cutter cable.

In one embodiment, the platform includes a jacket that has multiple vertical or inclined members and the cable is moved back and forth until the multiple vertical and inclined members of the jacket are cut.

In one embodiment, the platform is anchored to the seabed with multiple piling members and the cable is moved back and forth until multiple piling members of the platform are cut.

In one embodiment, the winches move the cable back and forth.

The present invention includes a method of removing an abandoned marine platform that extends below a water surface and into a seabed below a mud line, the platform having platform legs to be cut. The method provides a lift device and one or more frame sections, lowering the frame sections with the lifting device downwardly to a selected location below the water surface, placing the frame section next to the platform at selected locations, using the frame to support a movable cutter cable, wherein at least a first portion of the cutter cable extends between the mud line and at least a second portion of the cutter cable forms an angle with the said first portion, and moving the first and second portions of the cable relative to the frame sections while taking up the cable to cut one or more of the platform leg.

In one embodiment, the cable is pulled in a first direction and then a second direction while engaging the platform leg or legs to be cut.

In one embodiment, the platform has multiple jacket leg members and the cable is moved back and forth until multiple legs of the platform are cut.

In one embodiment, the platform includes a jacket that has multiple vertical or inclined members and the cable is moved back and forth until multiple of the vertical and inclined members of the jacket are cut.

In one embodiment, the platform is anchored to the seabed with multiple piling members and the cable is moved back and forth until multiple of the piling members of the platform are cut.

In one embodiment, winches are mounted on the lift device and further comprising powering the winches sequentially to pay out and take up cable in order to move the cable back and forth.

The present invention includes a method of removing an abandoned marine platform that extends above and below a water surface. The method provides a floating lifting device, one or more frame sections, and multiple winches, affixing the winches to a work platform at a selected location, wherein the work platform is rigged to be lifted or lowered by the lifting device, rigging a cutter cable to the frame sections and to the winches, one end of the cutter cable being wound upon one winch, the other end of the cutter cable being wound on another winch, moving the cable to cut the platform along a selected cut line, below the seabed, wherein each frame section has a digger arm that moves relative to the frame section, and wherein the cutter cable spans from a digger arm on one frame section to the digger arm on the other frame section.

In one embodiment, the winches gradually shorten the cable by taking up the cable upon one or both of said winches.

In one embodiment, the cutter cable is shortened by taking up the cable upon both of the winches.

In one embodiment, the winches are mounted on the work platform above the water surface.

In one embodiment, the present invention includes moving the cable in a first direction and then moving the cable in a second direction that is not the first direction.

In one embodiment, the present invention includes moving the cable in a first direction and then moving the cable in a second direction that is generally opposite the first direction.

In one embodiment, each frame section has an anchor arm that moves to engage the seabed.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a perspective view of a preferred embodiment of the apparatus of the present invention;

FIG. 2 is a partial elevation view of a preferred embodiment of the apparatus of the present invention;

FIG. 3 is a partial elevation view of a preferred embodiment of the apparatus of the present invention;

FIG. 4 is a partial plan view of a preferred embodiment of the apparatus of the present invention;

FIG. 5 is a partial elevation view of a preferred embodiment of the apparatus of the present invention;

FIG. 6 is a partial perspective view of a preferred embodiment of the apparatus of the present invention;

FIG. 7 is a fragmentary perspective view of a preferred embodiment of the apparatus of the present invention;

FIG. 8 is a fragmentary view of a preferred embodiment of the apparatus of the present invention;

FIG. 9 is a fragmentary view of a preferred embodiment of the apparatus of the present invention;

FIG. 10 is a fragmentary view of a preferred embodiment of the apparatus of the present invention; and

FIGS. 11-13 are sequential views that illustrate the method and apparatus of the present invention.

### DETAILED DESCRIPTION OF THE INVENTION

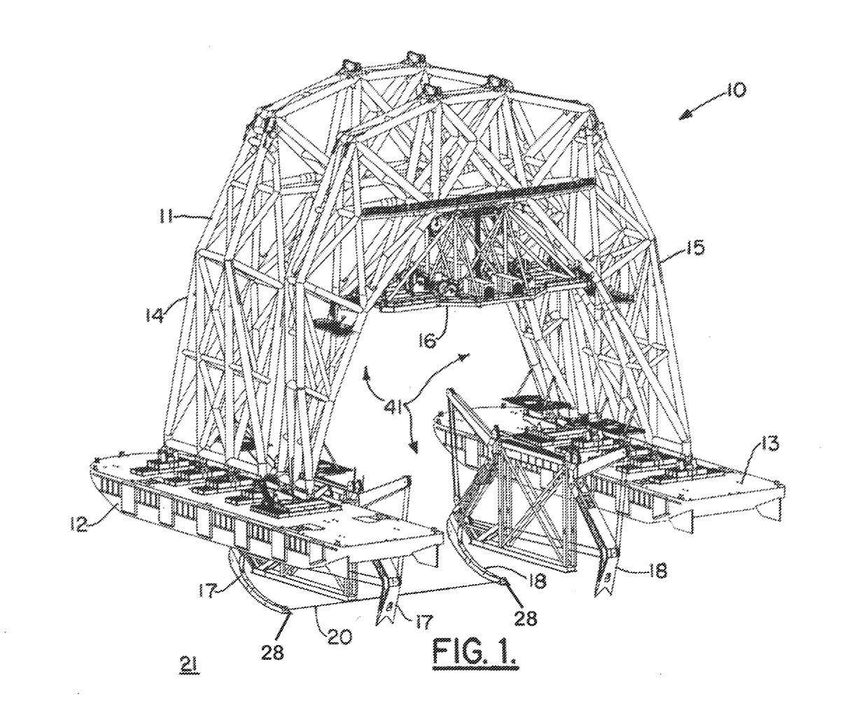

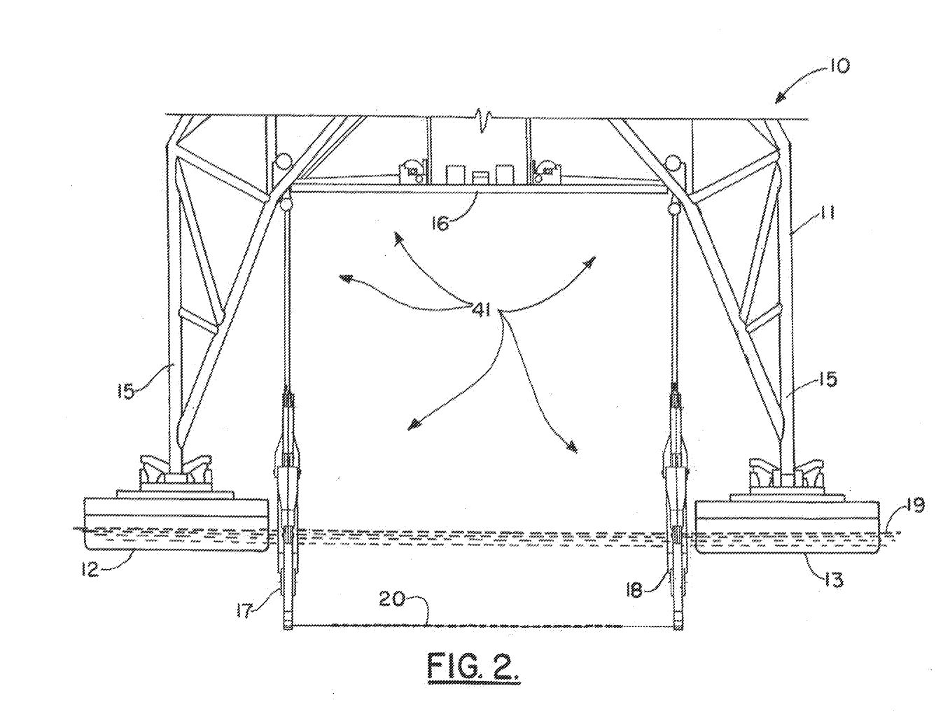

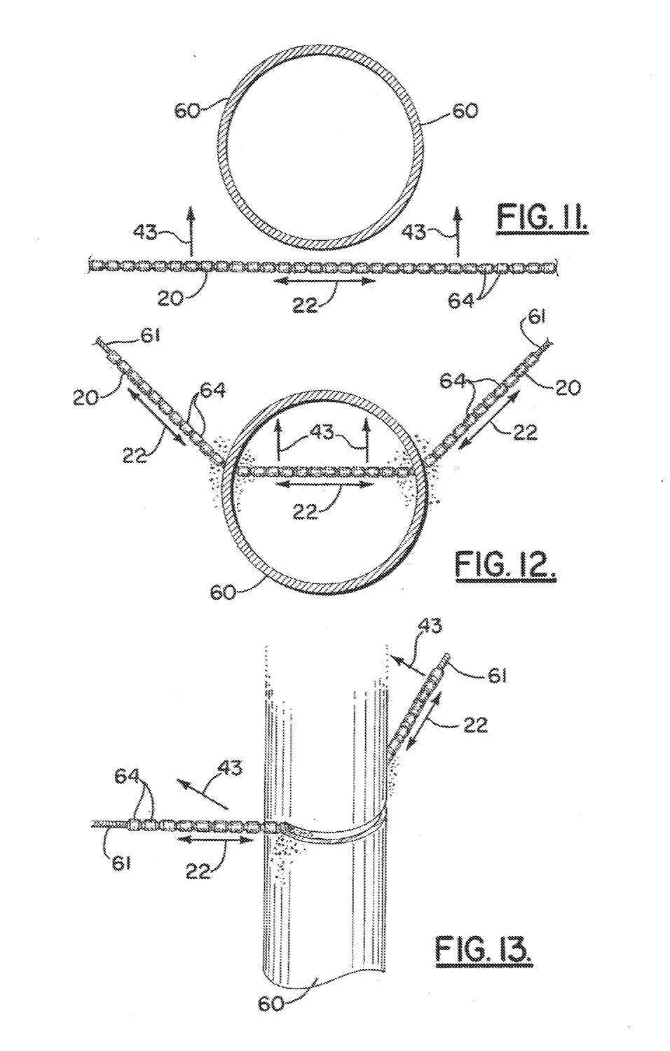

FIGS. 1-13 show generally a preferred embodiment of the marine platform salvaging apparatus of the present invention designated generally by the numeral 10 in FIG. 1. In FIGS. 1-6 there can be seen a seabed or mud line area 21. The mudline is basically the upper surface of a seabed in the Gulf of Mexico or other water body where there is only soft sediment or mud and no rock at the water bottom. A water surface 19 is shown at a distance above seabed 21 in FIGS. 2, 3 and 5. When offshore or other marine platforms (e.g., storm damages or abandoned) are to be removed, safety concerns and federal regulations typically mandate removal including portions that are below the mudline.

A marine platform 60 to be removed is mounted in or anchored to seabed 21. Such a marine platform 60 often includes one or more piling and/or a jacket that is anchored to the seabed using piling. Such piling are driven into the seabed well below the mudline 21. Such a marine platform 60 can provide a deck area that houses production equipment, supplies and/or oil well drilling equipment. A heliport is provided on larger such marine platforms 60 for enabling helicopters to land and exchange crew members.

Lifting apparatus 11 is shown in FIGS. 1-5. The lifting apparatus 11 can be any device that can be used to raise and lower first and second girder assemblies 17, 18. Frames 14, 15 support work platform 16 at an elevated position above hulls 12,13 as seen in FIGS. 1-4. In FIGS. 1-5, the lifting device 11 shown can employ spaced apart vessel or hulls 12, 13. Each vessel or hull 12, 13 supports a pair of frames 14, 15. The frames 14, 15 are generally an inverted u-shaped, providing an open area or space 41 between hulls 12, 13 and under each frame 14, 15 as shown in FIGS. 1-3. Lifting apparatus 11 can be the type shown and described in U.S. Pat. Nos. 7,527,006, 7,845,296, 7,886,676, 8,061,289, and 8,240,264, each patent hereby incorporated herein by reference.

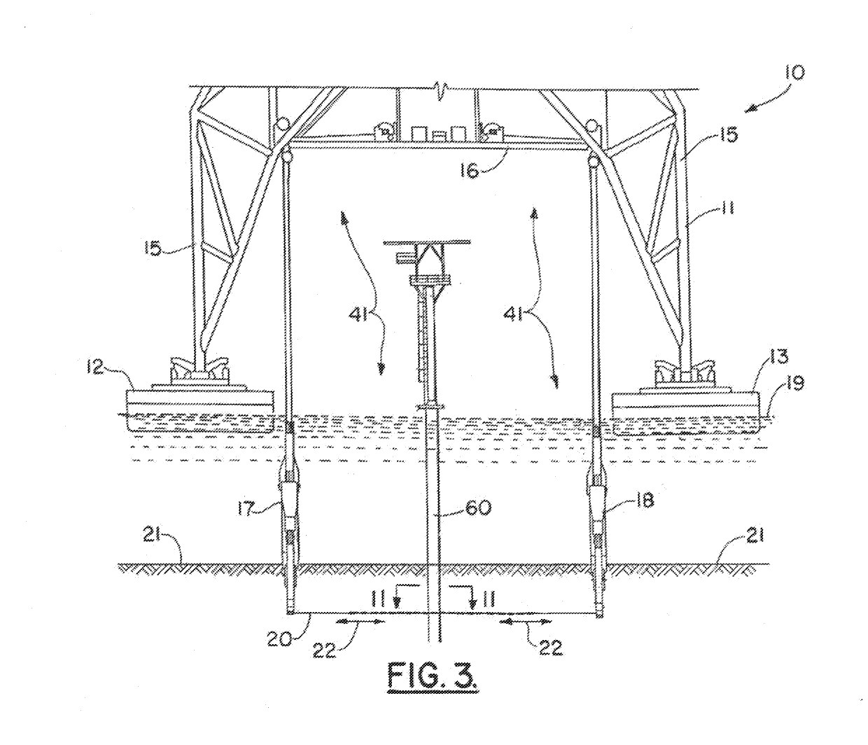

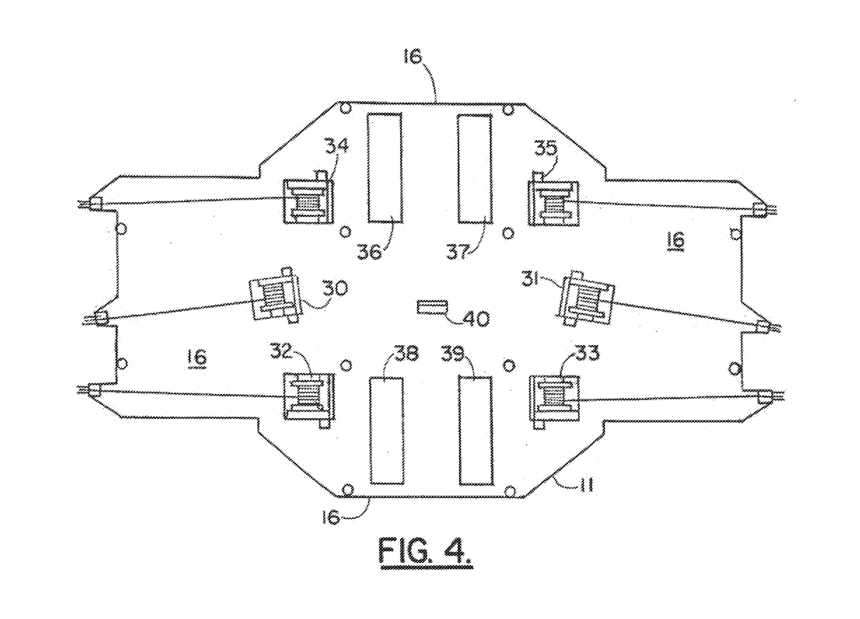

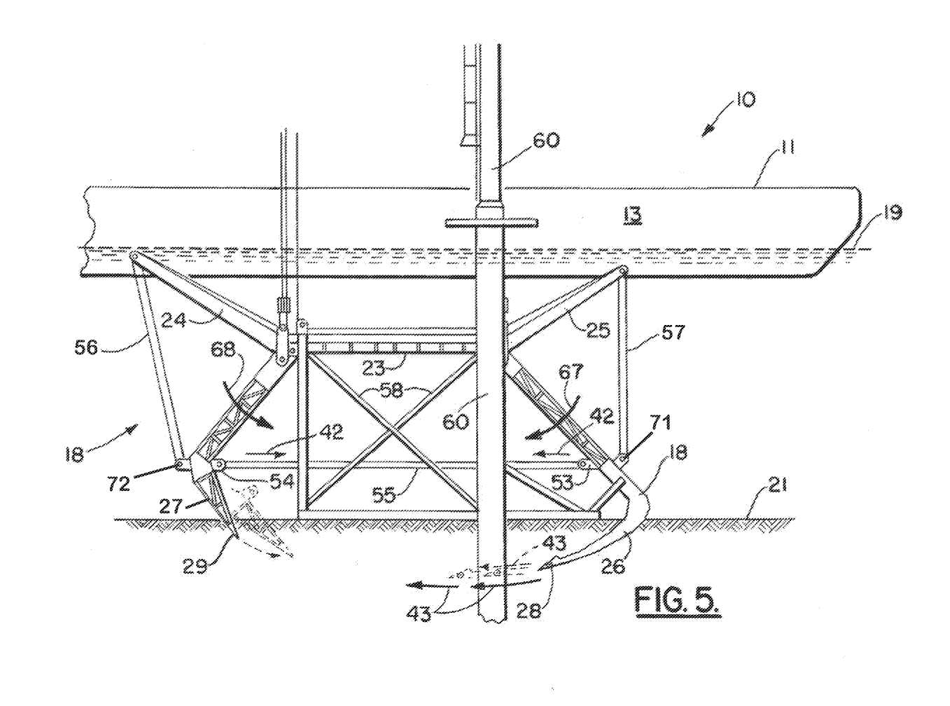

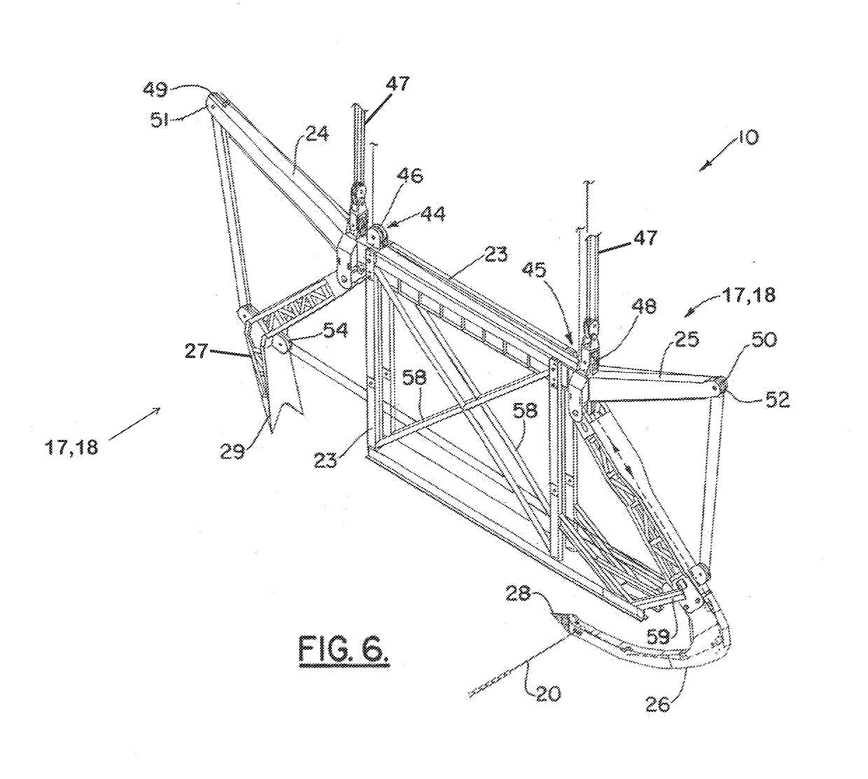

Lifting apparatus 11 supports platform 16 which is used to lift and lower two girder assemblies or sections 17, 18. FIGS. 5-6 show the girder assemblies 17, 18 in more detail. A cutter cable 20 is mounted on each girder section 17, 18 and spans between girder sections 17, 18 (see FIGS. 1-3 and 6) extending from tip portion 28 of one girder section 17 to tip portion 28 of the other girder section 18. In order to cut a leg or legs of an abandoned marine platform 60, the cutter cable 20 is moved back and forth (see double arrows 22, FIGS. 3, 11-13) while a digger arm 26 of each girder section 17, 18 advances in the direction of arrows 43 toward the leg or legs to be cut (see FIGS. 5 and 11-13). Winches 30-35 are provided on the work platform 16 (see FIGS. 2-4). Two of the winches 30, 31 are used to move the cutter cable 20 back and forth as seen by double arrow 22 in FIGS. 3, 11-13. The other four winches 32-35 are used to move the arms 26, 27 of each girder section 17, 18 toward each other as indicated by arrows 67, 68 in FIG. 5. A first section of cable 20 attaches to a first winch 30 on platform 16. A second section of cable 20 attaches to a second winch 31 on platform 16.

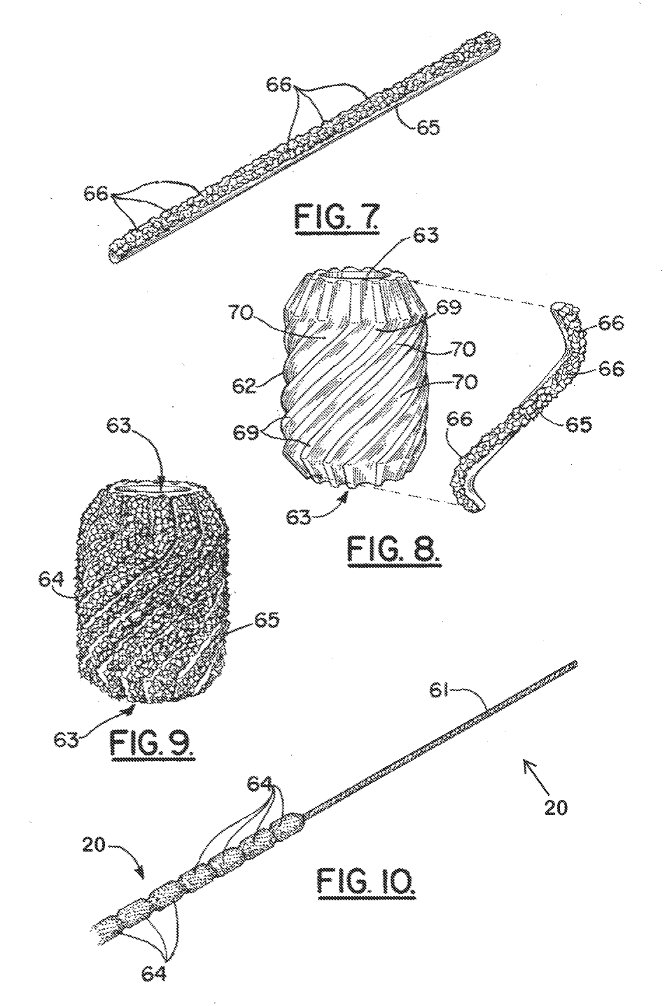

The cutting cable 20 can be a wire rope 61 such as 2-3 inch (5-8 cm) diameter wire rope 61 fitted with a plurality of cutting members 64 (see FIGS. 6 and 10-13). Each cutting member 64 can include a cylindrically shaped sleeve 62 (see FIG. 8) having an open ended bore 63 that receives the wire rope 61 and an outer surface that is covered with a plurality of helical or spiral projections or ribs 69 (see FIG. 8). A groove 70 can be provided between each pair of ribs 69. Each projection or rib 69 can be covered with tungsten carbide cutting elements 66. Each of the cutting members 64 is mounted upon cable 20 as seen in FIG. 10. The tungsten carbide elements 66 could alternatively be mounted to a member 65 (see FIGS. 7-8) which would then be welded to the ribs 69 (or grooves 70) on sleeve 62. The finished cutting member 64 is seen in FIG. 9. In FIG. 7, member 65 is initially a linear bar that is covered with tungsten carbide or like cutting elements 66. In FIG. 8, the member 65 has been bent or spirally shaped to match the shape of ribs 69 or grooves 70.

A plurality of the cutting members 64 are mounted on the rope 61 preferably one next to another (see FIGS. 10-13). Clamps, sleeves, wedge locking devices, welding or cable straps can be used to hold the cutting members 64 in a fixed position on the cable 20. In one embodiment, clamps, sleeves, or wedge locking fittings are placed on each end of the plurality of cutting members 64. The cable 20 is moved back and forth using two of the winches 30, 31 on platform 16 (arrow 22, FIGS. 3, 11-13) while the cable 20 itself is advanced toward and through the platform 60 to be removed (see arrows 43, FIGS. 5, 11-13). Advancement of the cable can be below mudline 21 (see FIG. 5).

The pair of winches 30, 31 operating cable 20 can be programmed so that as one winch 30 on work platform 16 is paying out the cable 20, the other winch 31 on the platform 16 is winding in cable 20. This procedure is then reversed. In order to advance the cable 20 through the various members of the platform 60, platform jacket or platform legs, the cable 20 can be advanced in the direction of arrow 43 until all of the members of the platform or jacket that extend below the mudline 21 are severed. The winches 30, 31 can also be programmed to take up any slack of cable 20 as it continues to cut through the various members of jacket or platform 60 that are below the mudline 21.

In FIGS. 1-3 and 5-6, each girder section or girder assembly 17, 18 includes a frame 23 that can be generally square or rectangular. Each girder section 17, 18 has boom arm 24 mounted to an upper corner 44 of girder frame 23. Another boom arm 25 is mounted to upper corner 45 of frame 23. Boom 24 has sheave 49 at boom end 51. Boom 25 has sheave 50 at boom end 52. The provided sheaves 49, 50 enable wire rope or other cabling to be rigged from a selected winch 30-35 to a boom 24 or 25 and then to an arm 26 or 27 of a girder assembly 17 or 18. The winches 32, 33 and 34, 35 can thus lift or lower a selected arm 26 or 27. Sheaves can also be provided to rig wire rope 61 from winch 30 or 31 to girder assembly 17 or 18 for moving cable 20 during cutting. Corner 44 also provides one or more sheaves at 46. Corner 45 has one or more sheaves 48. Girder assemblies 17, 18 can be lifted and lowered using winches (not shown) on platform 16 and cables or lifting lines 47. Sheaves at 46, 48 are rigged with wire rope or cable from a winch 32-35 which is rigged to a sheave 49 or 50 and then rigged to a sheave 71 or 72 for lifting a selected arm 26 or 27.

Each frame 23 has digger arm 26 pivotally mounted to frame 23 at corner 45. Each frame 23 has anchor arm 27 pivotally mounted to frame 23 at corner 44. The digger arm 26 can be provided with a jetting tip portion 28. The arm 27 can be provided with an anchor tip 29 (e.g., forked as shown) which digs into the mud to anchor frame 23 into the mud below line 21. Sheaves 53, 54 are provided for enabling arms 26, 27 to be pulled toward each other (see arrows 42, FIG. 5) with cabling at location 55 (see FIG. 5). Cabling at location 56 enables arm 26 to be lifted up toward boom 24. Similarly, cabling at location 57 enables arm 27 to be pivoted upwardly toward boom 25. Such cabling 55-57 can be shortened or lengthened using sheaves and one or more of the winches 32-35 on platform 16.

Frame 23 can be cross braced with cross brace members 58. In the embodiments shown, six (6) winches 30-35 are provided on platform 16. Winches 32-35 are provided on platform 16, one for each arm 26, 27 on each girder frame 23 of each girder section 17 or 18. FIG. 4 is a plan view showing the six (6) winches 30-35 that are used to: (1) raise and lower a selected arm 26 or 27 for each girder section 17, 18; and (2) two winches 30, 31 move cable assembly 20 back and forth for cutting.

One or more hydraulic power units (hpu) 36-39 are provided on platform 16 to power the winches 30-35 as shown in FIG. 4. A control panel 40 enables a user to operate each winch. Work platform 16 can be lifted/lowered from frames 14, 15 using winches, sheaves and cabling that are mounted on the frames 14, 15 and/or on the hulls 12, 13.

Cabling and sheaves can be provided for enabling a selected winch to lift a selected arm 26, 27. Cabling and sheaves can be provided for enabling a selected winch to lift or lower a selected girder section 17 or 18. A stop 59 can be provided to limit downward movement of arm 26. Stop 59 can provide laterally supporting beams that prevent lateral movement of jetting tip portion 28 during cutting with cable 20.

The following is a list of parts and materials suitable for use in the present invention:

PARTS LIST:

| PART NUMBER | DESCRIPTION |
|---|---|
| 10 | marine platform salvaging apparatus |
| 11 | lifting apparatus |
| 12 | hull |
| 13 | hull |
| 14 | frame |
| 15 | frame |
| 16 | work platform |
| 17 | first girder section/assembly |
| 18 | second girder section/assembly |
| 19 | water surface area |
| 20 | cutter cable |
| 21 | seabed/mud line area/mud line |
| 22 | arrow |
| 23 | girder frame |
| 24 | boom/arm |
| 25 | boom/arm |
| 26 | digger arm |
| 27 | anchor arm |
| 28 | jetting tip portion |
| 29 | anchor tip/forked anchor tip |
| 30 | winch |
| 31 | winch |
| 32 | winch |
| 33 | winch |
| 34 | winch |
| 35 | winch |
| 36 | hydraulic power unit |
| 37 | hydraulic power unit |
| 38 | hydraulic power unit |
| 39 | hydraulic power unit |
| 40 | control panel |
| 41 | open space/area |
| 42 | arrow |
| 43 | arrow |
| 44 | upper corner |
| 45 | upper corner |
| 46 | sheave |
| 47 | lifting line |
| 48 | sheave |
| 49 | sheave |
| 50 | sheave |
| 51 | boom end |
| 52 | boom end |
| 53 | sheave |
| 54 | sheave |
| 55 | cabling/location |
| 56 | cabling/location |
| 57 | cabling/location |
| 58 | cross brace member |
| 59 | stop |
| 60 | marine platform |
| 61 | wire rope |
| 62 | cutter element sleeve |
| 63 | open ended bore |
| 64 | cutter element/member |
| 65 | helical/spiral member |
| 66 | tungsten carbide element |
| 67 | arrow |
| 68 | arrow |
| 69 | spiral rib |
| 70 | groove |
| 71 | sheave |
| 72 | sheave |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A method of removing an abandoned marine platform that extends above and below a water surface and into a seabed, comprising the steps of:
a) providing frame sections and multiple winches;
b) affixing the winches to a work platform;
c) rigging a cutter cable to the frame sections and to the winches, one end of the cutter cable being wound upon a first winch, the other end of the cutter cable being wound on a second winch; and
d) moving the cable to cut the platform along a selected cut line, wherein the winches gradually shorten the cable during such cutting.

2. The method of claim 1 wherein in step “d” the winches gradually shorten the cable by taking up the cable upon one or both of said winches.

3. The method of claim 1 wherein in step “d” the cutter cable is shortened by taking up the cable upon both of the winches.

4. The method of claim 3 wherein the winches are mounted on the work platform above the water surface.

5. The method of claim 1 wherein step “d” includes moving the cable in a first direction and then moving the cable in a second direction that is not the first direction.

6. The method of claim 5 wherein step “d” includes moving the cable in a first direction and then moving the cable in a second direction that is generally opposite the first direction.

7. The method of claim 1 wherein each frame section has an anchor arm that moves to engage the seabed.

8. The method of claim 1 wherein each frame section has a plurality of sheaves and in step “c” the cable is rigged to a digger arm that moves to engage the seabed.

9. The method of claim 1 further comprising the step of providing a lifting device and lowering the frame sections to the seabed, wherein a lower portion of each frame section is lowered until below the seabed.

10. The method of claim 1 wherein in step “d” the cable is moved by winding up cable on one winch while paying out cable from the other winch.

11. The method of claim 1 wherein the cutter cable includes a plurality of sleeves placed upon a wire rope cable.

12. The method of claim 11 wherein the sleeves have an outer coating of tungsten carbide members.

13. A method of removing an abandoned marine platform that extends below a water surface, comprising the steps of:
a) providing a lifting device having winches and multiple frame sections;
b) lowering the frame sections from the lifting device downwardly with winches mounted on the lifting device to a selected location below the water surface;
c) placing the frame sections next to the platform;
d) using the frame sections to support a movable cutter cable, and wherein the movable cutter cable has first and second end portions, wherein the first end portion is wound upon a first said winch and the second end portion is wound upon a second said winch;
e) moving the first and second portions of the cutter cable relative to the frame sections while taking up the cable with the winches; and
f) cutting the platform with the cable during step “e”.

14. The method of claim 13 wherein in step “e” the cable is pulled in a first direction with the first said winch and then a second direction with the second said winch while engaging the platform to be cut.

15. The method of claim 13 wherein the platform has multiple jacket leg members and the cable is moved back and forth until multiple leg members of the platform are cut with the cutter cable.

16. The method of claim 13 wherein the platform includes a jacket that has multiple vertical or inclined members and the cable is moved back and forth until the multiple vertical and inclined members of the jacket are cut.

17. The method of claim 13 wherein the platform is anchored to the seabed with multiple piling members and the cable is moved back and forth until multiple piling members of the platform are cut.

18. The method of claim 15 wherein the winches move the cable back and forth during step “e”.

19. A method of removing an abandoned marine platform that extends below a water surface and into a seabed below a mud line, said platform having platform legs to be cut, comprising the steps of:
a) providing a lift device and one or more frame sections;
b) lowering the frame sections with the lifting device downwardly to a selected location below the water surface;
c) placing the frame section next to the platform at selected locations;
d) using the frame to support a movable cutter cable;
e) wherein in step “c” at least a first portion of the cutter cable extends below the mud line and at least a second portion of the cutter cable forms an angle with the said first portion; and
f) moving the first and second portions of the cable relative to the frame sections while taking up the cable to cut one or more of the platform leg.

20. The method of claim 19 wherein in step “f” the cable is pulled in a first direction and then a second direction while engaging the platform leg or legs to be cut.

21. The method of claim 19 wherein the platform has multiple jacket leg members and the cable is moved back and forth until multiple legs of the platform are cut.

22. The method of claim 19 wherein the platform includes a jacket that has multiple vertical or inclined members and the cable is moved back and forth until multiple of the vertical and inclined members of the jacket are cut.

23. The method of claim 19 wherein the platform is anchored to the seabed with multiple piling members and the cable is moved back and forth until multiple of the piling members of the platform are cut.

24. The method of claim 19 wherein winches are mounted on the lift device and further comprising powering the winches sequentially to pay out and take up cable in order to move the cable back and forth.

25. A method of removing an abandoned marine platform that extends above and below a water surface, comprising the steps of:
a) providing a floating lifting device, one or more frame sections, and multiple winches;
b) affixing the winches to a work platform at a selected location, wherein the work platform is rigged to be lifted or lowered by the lifting device;
c) rigging a cutter cable to the frame sections and to the winches, one end of the cutter cable being wound upon one winch, the other end of the cutter cable being wound on another winch;
d) moving the cable to cut the platform along a selected cut line, below the seabed;
e) wherein each frame section has a digger arm that moves relative to the frame section; and
f) wherein the cutter cable spans from a digger arm on one frame section to the digger arm on the other frame section.

26. The method of claim 25 wherein in step “d” the winches gradually shorten the cable by taking up the cable upon one or both of said winches.

27. The method of claim 25 wherein in step “d” the cutter cable is shortened by taking up the cable upon both of the winches.

28. The method of claim 27 wherein the winches are mounted on the work platform above the water surface.

29. The method of claim 25 wherein step “d” includes moving the cable in a first direction and then moving the cable in a second direction that is not the first direction.

30. The method of claim 29 wherein step “d” includes moving the cable in a first direction and then moving the cable in a second direction that is generally opposite the first direction.

31. The method of claim 25 wherein each frame section has an anchor arm that moves to engage the seabed.

32. (canceled)
